(19) United States
(12) Patent Application Publication
(10) Pub. No.: US 2018/0243678 A1
(43) Pub. Date: Aug. 30, 2018

(54) FILTER ELEMENT COMPRISING A FRAME ELEMENT

(71) Applicant: CARL FREUDENBERG KG, Weinheim (DE)

(72) Inventor: Alexandra LAZAREVIC, Stuttgart (DE)

(21) Appl. No.: 15/752,891

(22) PCT Filed: Oct. 13, 2016
(86) PCT No.: PCT/EP2016/074548

§ 371 Date: Feb. 15, 2018

(30) Foreign Application Priority Data
Nov. 20, 2015 (EP) EP15195 545.7

(51) Int. Cl. B01D 46/10; B01D 46/00; B01D 46/52

(52) U.S. Cl. CPC B01D 46/10; B01D 46/521; B01D 46/0002; B01D 46/0001

(57) ABSTRACT

A filter element includes a boot made of nonwoven fabric. A penultimate pleat wall and/or a final pleat wall and/or a final pleat ridge is or are at least partially overlapped by a frame element made of nonwoven fabric. In an embodiment, the frame element overlaps the penultimate pleat wall and the final pleat wall and the final pleat ridge common thereto.

### CROSS-REFERENCE TO PRIOR APPLICATIONS

This application is a U.S. National Phase application under 35 U.S.C. § 371 of International Application No. PCT/EP2016/074548, filed on Oct. 13, 2016, and claims benefit to European Patent Application No. EP 15195545.7, filed on Nov. 20, 2015. The International Application was published in German on May 26, 2017 as WO 2017/084810 under PCT Article 21(2).

### FIELD

The invention relates to a filter element and to a method for producing a filter element.

### BACKGROUND

A filter element of this kind is already known from EP 1 616 736 A1. In FIG. 5 of the above-mentioned document, a filter element is shown having a boot, in which a final pleat wall and a final pleat ridge are at least partially overlapped by a frame element. The frame element known from this document is rubber-elastic.

However, elastomers and rubbers are relatively expensive and hard to dispose of.

### SUMMARY

In an embodiment, the present invention provides a filter element comprising: a boot comprising nonwoven fabric, wherein a penultimate pleat wall and/or a final pleat wall and/or a final pleat ridge is or are at least partially overlapped by a frame element comprising nonwoven fabric.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a filter element in which the final two pleat walls and the pleat ridge common thereto are overlapped by a planar frame element,

FIG. 2 shows a filter element in which the final two pleat walls and the pleat ridge common thereto are overlapped by a planar frame element, the frame element comprising a planar limb that is oriented orthogonally to the filter plane and that projects upwards, i.e. towards the pleat ridge, by a free end,

FIG. 3 shows a filter element in which the final two pleat walls and the pleat ridge common thereto are overlapped by a planar frame element, the frame element comprising a first planar limb which is oriented orthogonally to the filter plane and against which a second planar limb bears that projects by a free end towards the pleat ridge and is thus oriented in parallel with the filter plane,

FIG. 4 shows a filter element in which the final two pleat walls and the pleat ridge common thereto are overlapped by a planar frame element, the frame element comprising a convexly curved end surface,

FIG. 5 shows a filter element in which the penultimate pleat wall and the final pleat ridge are overlapped by a planar frame element, the frame element comprising a convexly curved end surface, and

FIG. 6 schematically shows the method steps for producing filter elements of the type described here.

### DETAILED DESCRIPTION

It has been recognized according to the invention that a frame element made of nonwoven fabric is cost-effective. Furthermore, it has been recognized that a filter element comprising a boot made of nonwoven fabric and a frame element made of nonwoven fabric is easily incinerated, since said filter element is constructed from a single material.

The frame element could overlap the final two pleat walls and the pleat ridge common thereto. In this way, a longitudinal end of a boot is stabilized particularly well.

A planar limb could project upwards, i.e. towards the pleat ridge, by a free end from a surface which overlaps the final pleat wall. A planar limb of this kind may bear against a filter housing in a sealing manner as a sealing lip. Furthermore, the planar limb forms a straight edge when it projects orthogonally to the filter plane.

A first planar limb could project from a surface which overlaps the final pleat wall, a second planar limb projecting by a free end from said first planar limb. The second planar limb may be oriented orthogonally to the first, which is in turn oriented orthogonally to the filter plane. The second planar limb thus does not project beyond the boot, but rather ends flush with a side strip, which bears against pleat edges of the boot. Preferably, side strips are arranged on both sides of the boot.

A convexly curved end surface could project from a surface which overlaps the final pleat wall. The convexly curved end surface may act as a seal, since it can be placed against a wall of the filter housing in a tensioned manner.

A convexly curved end surface could project from a surface which overlaps only the penultimate pleat wall. The convexly curved end surface may act as a seal, since it can be placed against a wall of the filter housing in a tensioned manner. Preferably, the convexly curved end surface engages over the final pleat wall.

The boot could comprise at least one side strip that extends in the longitudinal direction of the boot. The side strip bears against the pleat edges and stabilizes the boot. Furthermore, the side strip acts as a seal.

In this context, it is conceivable for a side strip to be arranged on each side of the boot. As a result, the boot is stabilized particularly well.

The frame element is preferably adhesively bonded or welded to the boot.

The frame element could also be adhesively bonded on only the respective outer edges thereof. Said edges could in each case be adhesively bonded to side strips arranged on both sides. The frame element is secured only by means of the side strips, and therefore surface gluing to the end pleat is not necessary. It is also conceivable for just the edges to be adhesively bonded to the final and/or penultimate pleat wall.

Installing the frame element produces an additional sealing effect, since the frame element forms an additional convex end pleat having a high degree of inherent rigidity. As a result, it is almost impossible for leaks to occur.

Fitting a simple nonwoven fabric edge on the outer side of the end pleats may give rise to leaks, since sufficient inherent tension or stabilization of the end pleat cannot be achieved. The additional tension is produced by the interaction between a V-shaped frame element and the lateral gluing of the edge.

A method for producing a filter element of the type described here comprises the following method steps:

separating a segment which consists of at least two connected frame elements made of nonwoven fabric from a primary boot, placing the segment onto a secondary boot, fastening the segment to the secondary boot, preferably by means of adhesive bonding or welding, separating one boot comprising a frame element placed thereon from the secondary boot by dividing one segment into two parts.

The segment could be divided into two identical parts. In this way, filter elements can be manufactured in a continuous manner without subsequent machining steps.

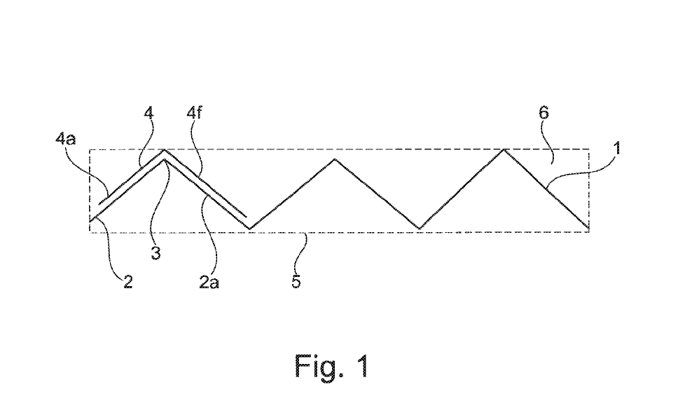

FIG. 1 shows a filter element comprising a boot 1 made of nonwoven fabric, a final pleat wall 2 and a final pleat ridge 3 being at least partially overlapped by a frame element 4 made of nonwoven fabric. The frame element 4 overlaps the final two pleat walls 2, 2a and the pleat ridge 3 common thereto.

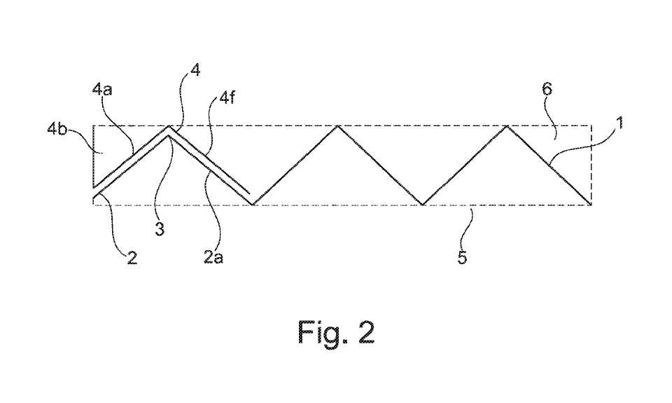

FIG. 2 shows a filter element in which a planar limb 4b projects upwards, i.e. towards the pleat ridge 3, by a free end from a surface 4a which overlaps the final pleat wall 2.

FIG. 2 specifically shows a filter element in which the final two pleat walls 2, 2a and the pleat ridge 3 common thereto are overlapped by a planar frame element 4, the frame element 4 comprising a planar limb 4b that is oriented orthogonally to the filter plane 5 and that projects upwards, i.e. towards the pleat ridge 3, by a free end.

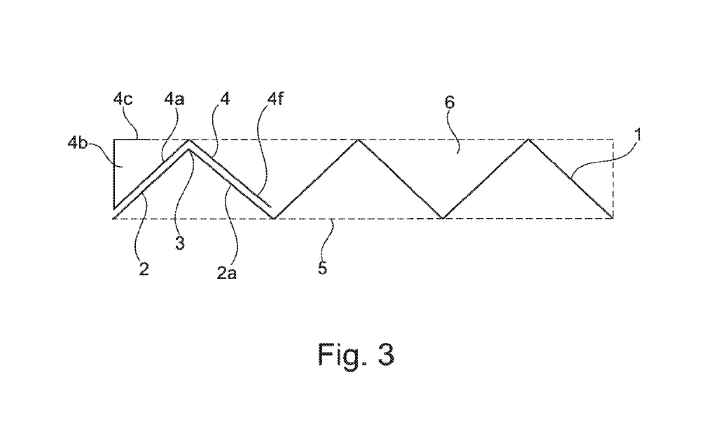

FIG. 3 shows a filter element in which a first planar limb 4b projects from a surface 4a which overlaps the final pleat wall 2, a second planar limb 4c projecting by a free end from said first planar limb.

FIG. 3 specifically shows a filter element in which the final two pleat walls 2, 2a and the pleat ridge 3 common thereto are overlapped by a planar frame element 4, the frame element 4 comprising a planar limb 4b which is oriented orthogonally to the filter plane 5 and against which a second planar limb 4c bears that projects by a free end towards the pleat ridge 3 and is thus oriented in parallel with the filter plane 5.

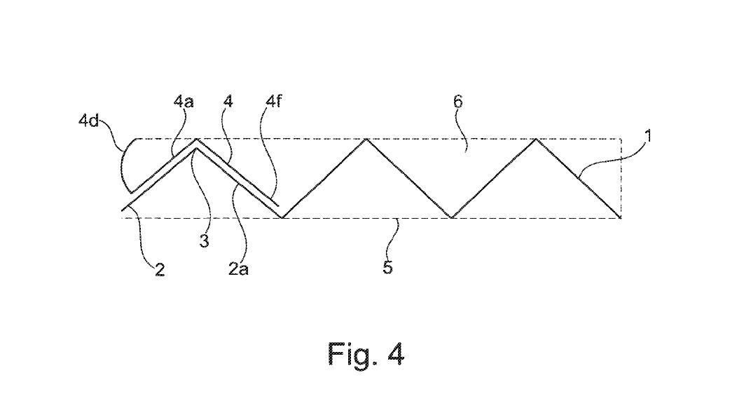

FIG. 4 shows a filter element in which a convexly curved end surface 4d projects from a surface 4a which overlaps the final pleat wall 2.

FIG. 4 specifically shows a filter element in which the final two pleat walls 2, 2a and the pleat ridge 3 common thereto are overlapped by a planar frame element 4, the frame element 4 comprising a convexly curved end surface 4d. The convexly curved end surface 4d comprises a free end which projects upwards, i.e. towards the pleat ridge 3.

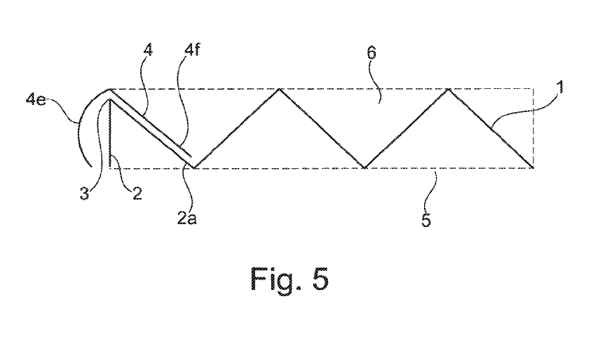

FIG. 5 shows a filter element in which a convexly curved end surface 4e projects from a surface 4f which overlaps only the penultimate pleat wall 2a. The convexly curved end surface 4e comprises a free end which projects downwards, i.e. towards the free end of the final end pleat 2.

FIG. 5 specifically shows a filter element in which the penultimate pleat wall 2a and the final pleat ridge 3 are overlapped by a planar frame element 4, the frame element 4 comprising a convexly curved end surface 4e. The final pleat wall 2 can pivot freely and does not bear against the frame element 4.

FIGS. 1 to 5 show that the boot 1 comprises at least one side strip 6 that extends in the longitudinal direction of the boot 1, a side strip 6 being arranged on each side of the boot 1.

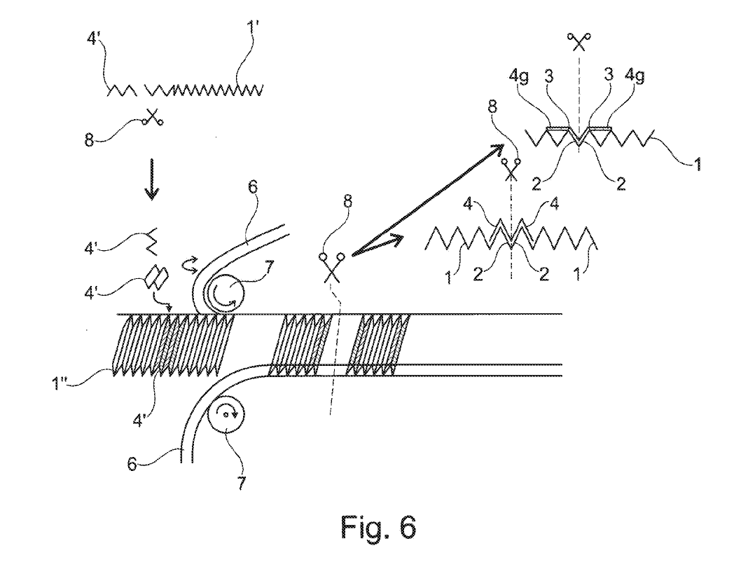

FIG. 6 shows a method for producing a filter element of the type described here, comprising the following method steps:

separating a segment 4′ which consists of at least two connected frame elements 4 made of nonwoven fabric from a primary boot 1′, placing the segment 4′ onto a secondary boot 1″, which is continuously guided between two rollers 7, fastening the segment 4′ to the secondary boot 1″, preferably by means of adhesive bonding or welding, on both sides of the secondary boot 1″ side strips 6 being pressed through the rollers 7 onto the secondary boot 1″ and being adhesively bonded or welded thereto, and separating one boot 1 comprising a frame element 4 placed thereon from the secondary boot 1″ by dividing one segment 4′ into two parts. The segment 4′ is divided into two identical parts. Cutting tools 8 are used for the dividing or separating. A cutting tool 8 cuts through both the segment 4′ and the secondary boot 1″ at the same time in order to release the boot 1 of the filter element therefrom. The separated boot 1 then comprises a frame element 4 placed thereon.

The method allows filter elements to be isolated from a secondary boot. Finished filter elements can thus be produced which are provided on both sides with frame elements 4.

FIG. 6 shows two filter elements which can be produced by means of the above-mentioned method, but also in another way.

The lower filter element shown on the right-hand side of FIG. 6 comprises a boot 1 made of nonwoven fabric, a final pleat wall 2 and a final pleat ridge 3 being overlapped by a frame element 4 made of nonwoven fabric. The frame element 4 overlaps the final two pleat walls 2, 2a and the pleat ridge 3 common thereto, as shown in FIG. 1.

The upper filter element shown on the right-hand side of FIG. 6 comprises a boot 1 made of nonwoven fabric, a final pleat wall 2 and a final pleat ridge 3 being overlapped by a frame element 4 made of nonwoven fabric. A planar limb 4g projects by a free end in parallel with the plane in which the pleat ridges lie and does not bear against a pleat wall 2a, as shown in FIG. 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. Filter A filter element comprising:
a boot comprising nonwoven fabric,
wherein a penultimate pleat wall and/or a final pleat wall and/or a final pleat ridge is or are at least partially overlapped by a frame element comprising nonwoven fabric.

2. The filter element according to claim 1, wherein the frame element overlaps the penultimate pleat wall and the final pleat wall and the final pleat ridge common thereto.

3. The filter element according to claim 1, wherein a planar limb projects towards the final pleat ridge by a free end from a surface which overlaps the final pleat wall.

4. The filter element according to claim 1, wherein a first planar limb projects from a surface which overlaps the final pleat wall, and
wherein a second planar limb projects by a free end from the first planar limb.

5. The filter element according to claim 1, wherein a convexly curved end surface projects from a surface which overlaps the final pleat wall.

6. The filter element according to claim 1, wherein a convexly curved end surface projects from a surface which overlaps the penultimate pleat wall.

7. The filter element according to claim 1, wherein the boot comprises at least one side strip that extends in a longitudinal direction of the boot.

8. The filter element according to claim 7, wherein a side strip is arranged on each side of the boot.

9. A method for producing the filter element according to claim 1, the method comprising:
separating a segment comprising at least two connected frame elements comprising nonwoven fabric from a primary boot;
placing the segment onto a secondary boot;
fastening the segment to the secondary boot; and
separating one boot comprising a frame element placed thereon from the secondary boot by dividing one segment into two parts.

10. The method according to claim 9, wherein the segment is divided into two identical parts.
